(19) United States
(12) Patent Application Publication
(10) Pub. No.: US 2005/0195840 A1
(43) Pub. Date: Sep. 8, 2005

(54) Method and system for preventing denial of service attacks in a network

(76) Inventors: Steven Krapp, Naperville, IL (US); Thomas Cloonan, Lisle, IL (US); Tim Doiron, Aurora, IL (US); Dan Hickey, Oswego, IL (US)

Correspondence Address: ARRIS INTERNATIONAL, INC, 3871 LAKEFIELD DRIVE, SUWANEE, GA, 30024, US

(21) Appl. No.: 11/070,374

(22) Filed: Mar. 2, 2005

Related U.S. Application Data
(60) Provisional application No. 60/521,164, filed on Mar. 2, 2004.

(51) Int. Cl. H04L 12/28

(52) U.S. Cl. 370/401; 370/230

(57) ABSTRACT

Leaky bucket state machines police packets and throttle packets of a stream or streams that are flowing from hosts towards the processor of a switch or router of a network. The throttling is performed by measuring and analyzing the actual flow rate(s) of the streams' packets. The actual flow rate(s) is compared to a predetermined threshold, which may be based on historical or estimated normal traffic patterns. If the actual flow rate exceeds the threshold associated with characteristics that relate packets to certain streams, packets are discarded from the streams having excessive flow rates. By discarding excessive packets having characteristics that correspond to packet information that typically causes a switch/router's processor to execute operations, the effects of a DoS attack are minimized while also minimizing the discarding of legitimate traffic packets.

### CROSS REFERENCE TO RELATED APPLICATION

This application claims priority under 35 U.S.C. 119(e) to U.S. provisional patent application No. 60/521,164 entitled “Method and apparatus for preventing denial of service attacks in an IP network,” which was filed Mar. 2, 2004, and is incorporated herein by reference in its entirety.

### FIELD OF THE INVENTION

This invention relates, generally, to communication networks and devices and, more particularly, to mitigating the effects of malicious attacks on the processor of a router or switch on the network.

### BACKGROUND

In a network, it is possible for a small number of hosts, for example, cable modems and other similar devices for sending communications information, to generate high-volume traffic that can be detrimental to the overall health of the network. There are several reasons why these hosts may be generating such traffic. For example, the hosts may be controlled by users with malicious intent, the hosts have been hi-jacked and are being remotely controlled by users with malicious intent, the hosts are infected with a virus, or there is a defect in the code of the host.

In all of these cases, the resulting effect of the stimulus within the network typically looks like a general Denial of Service (“DoS”) attack on the network. However, there are many different flavors of the DoS attacks. In general, the DoS attacks can be broken down into many different attack types, including the following: 1) network attack, 2) router/switch attack, 3) direct h host attack and 4) indirect host attack. In a “network attack,” the broadcast nature of the network is used to attack the network itself, as one or more hosts on the network launch a high volume of broadcast packets into the network. In the worst case scenario, the particular type of packets that are broadcast require the recipient hosts to spend a moderate number of processing cycles to process the packet. (Note: ARPs are one type of packet that might cause this problem, but all broadcast packets require some level of processing at each recipient host). This type of attack produces two undesirable effects in the network. First, all other hosts on the network must process the broadcast packets and must therefore consume precious processing resources, which slows down the other applications that might be running on the hosts. Second, the large percentage of network bandwidth that is consumed by the broadcast packets may limit the network bandwidth that is available for the other hosts to use.

Another type of DoS attack will be referred to as a “router/switch attack.” (Note: For purposes of discussion in this paper, the term “switch” will be used to mean either a Layer 3 router or a Layer 2 switch). In a switch attack, one or more hosts generate packets that must be processed by the central processing unit within the switch. These packets may be associated with ARP, DHCP, RIP, OSPF, BGP, ICMP or any other protocol type or characteristic that the switch processes. For a Layer 2 switch, this may also include packets to destinations that the switch does not know how to reach. This traffic with an unknown destination must be flooded to all hosts connected to the Layer 2 switch, creating an attack similar to the network attack described above. For a Layer 3 router, a similar problem can occur when the Layer 3 router receives a packet which has no route in the routing table or which has no ARP entry in the ARP cache.

In either case, the Layer 3 router may be configured to send an ICMP message back to the source host, and the resulting processing that is required to generate the ICMP message consumes processing resources on the Layer 3 router. While it is normal for hosts to generate packets that must be processed by the switch, during a typical switch attack one or more hosts will send these packets in a large enough quantity to exhaust the switch's central processor unit (“CPU”) processing capabilities. Once the switch CPU is overloaded, it may display many undesired operations. These may include halting the forwarding/routing of normal packet traffic, halting the processing of certain protocols (such as, for example, address resolution protocol (“ARP”), dynamic host control protocol (“DHCP”), router information protocol (“RIP”), open shortest path first (“OSPF”), border gateway protocol (“BGP”), internet control message protocol (“ICMP”), etc.), or re-setting and re-booting itself in a repetitive fashion as it repeatedly experiences the same set of stimuli.

The third type of DoS attack is a “direct host attack.” In a direct host attack, the attacker's stimuli are quite similar to those used for a switch attack, however the stimuli are directed against a single host instead of against a switch. The targeted host may be locally connected to the switch or it may be remotely located. The most common direct host attack is an ICMP ping flood. In this scenario, the attacker (or attackers) sends a high volume of ICMP pings to the targeted host, forcing the CPU on the targeted host to spend many processing cycles responding to the many arriving pings.

The fourth type of DoS attack is an “indirect host attack.” In this attack, the attacker (or attackers) spoofs the Source IP Address of the targeted host and sends many packets to routers. The packets are formatted with (for example) invalid Destination IP Addresses so that they will force the router to generate an ICMP unreachable message back to the Source IP Address on the offending packet. Since the attacker(s) spoofed the Source IP Address of the targeted host, all of the ICMP unreachable messages generated by the router are directed back at the targeted host. In the end, the result of the attack is to force the CPU on the targeted host to spend many processing cycles responding to the many arriving ICMP unreachable messages.

There have been some solutions for various DoS attack types. For example, network attacks are uncommon because most modern networks no longer use a shared medium to connect hosts, as shown in FIG. 1. Instead, most networks of today permit hosts to have a dedicated link connected to a switch or router in a star topology, as shown in FIG. 2. The switches or routers have tools that minimize the number of forward broadcasts to the links within the network. The tools include the filtering of directed broadcast packets. These tools also include proxy ARP, which, as known in the art, involves a request that a switch respond with a unicast ARP response to a requesting host if the requested IP address is in the switch's ARP cache. The tools also include the limitation of broadcast packets to a subset of the dedicated links because of IGMP snooping, which permits the switch to identify the links that desire receipt of a particular broadcast address.

Direct host attacks and indirect host attacks present problems in modern networks. Typically, a host that is under attack will complain to their IT department, or service provider, and only after sniffing the network and identifying the source of the attack can they add filters and Access Control Lists (“ACL”) to drop the packets associated with those attackers. Unfortunately, this approach requires human intervention, and the time required to solve the problem can oftentimes be longer than the targeted host would like.

Moreover, router/switch attacks are problematic within modern networks. A few solutions have been developed, but these solutions typically present undesirable side effects. A method currently employed by modern switches is to limit the rate at which packets are accepted by a processor of the switch via a filter or an ACL. Although this may mitigate the effects of a switch attack, primarily CPU exhaustion, there is an undesirable side effect of this particular solution. If the packet rate directed at the switch CPU exceeds a pre-defined maximum threshold, then packets are typically randomly dropped (“throttled”) to ensure that the rate of packets arriving at the CPU is lower than the maximum threshold. The packets sent by the attackers are equally likely to be dropped as are packets sent by hosts attempting to send legitimate traffic. However, since the attackers are sending a greater quantity of packets than the hosts trying to do meaningful work, it is more likely that a larger percentage of the packets that make it through the throttle to the CPU will be packets associated with the attacker. Thus, more CPU cycles will be wasted on the processing of attacker packets than will be spent on processing the legitimate packets. Accordingly, an attacker's packets essentially starve the hosts that are well behaved by denying access to the CPU-based services that they are requesting from the switch.

Therefore, there is a need for a method and system that can mitigate the effects of a malicious attack on a central device, such as a router or switch, while facilitating network traffic packets from legitimate users reaching the central device.

### SUMMARY

A method and system mitigates the effects of a malicious DoS attack on a central device, such as a router or switch, while facilitating network traffic packets from legitimate users reaching the central device or other network devices. The steps for performing this may include monitoring and measuring the bandwidth usage, or packet flow rate, of a traffic stream corresponding to each of a plurality of hosts connected to a network for each of a plurality of common characteristics. The measured bandwidth usage, or packet rate, for each characteristic type for each host's traffic stream is compared to a predetermined protocol-specific threshold during a sample period. Packets that cause the packet count of a given stream to exceed a corresponding threshold during a sample period are discarded.

In addition to monitoring traffic streams on a per-common characteristic, per-host basis, traffic streams may also be monitored and measured on a per-characteristic, per-central-device basis. Thus, in addition to potentially dropping packets from a given host directed toward a central device, aggregate traffic of a given type, or characteristic, from a plurality of hosts may be compared to a central device characteristic threshold. If the total number of packets of a given characteristic, or type, received during a sample period exceeds a threshold established for that given characteristic, packets that are received during the sample period that causes the count to exceed the threshold may be dropped.

Another aspect monitors and measures the aggregate traffic from a particular host, or group of hosts, toward a central device, such as a switch or router. If the aggregate traffic from a host, or group of hosts, exceeds a predetermined threshold, packets that are received after the predetermined number of packets have been received during a predetermined sample period are dropped.

Another aspect monitors and measures the aggregate traffic received at a particular central device from all hosts. If the total of packets received at the central device for a given characteristic relating multiple streams exceeds a predetermined threshold associated with the characteristic during a predetermined sample period, packets that are received during the sample period after the number of received packets during the sample period exceeds the threshold are dropped, or discarded.

### BRIEF DESCRIPTION OF DRAWINGS

FIG. 1 illustrates a network configuration where hosts are connected to one another over a common medium.

FIG. 2 illustrates a network configuration where hosts are connected to one another via a central device.

FIG. 3 illustrates a configuration of packet analyzers corresponding to a single host, or single group of hosts.

FIG. 4 illustrates a multi stage configuration of packet analyzers in a network.

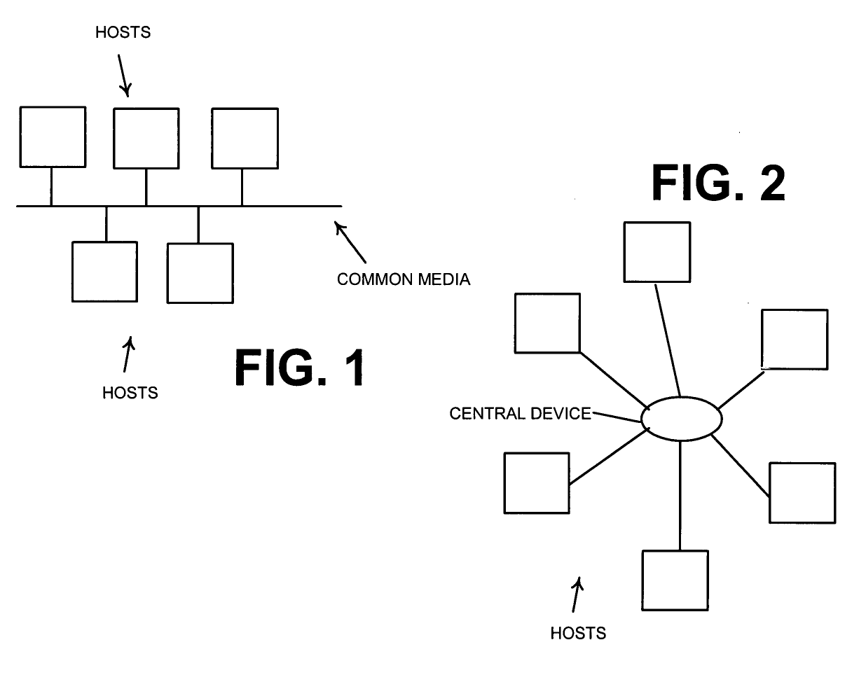

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof.

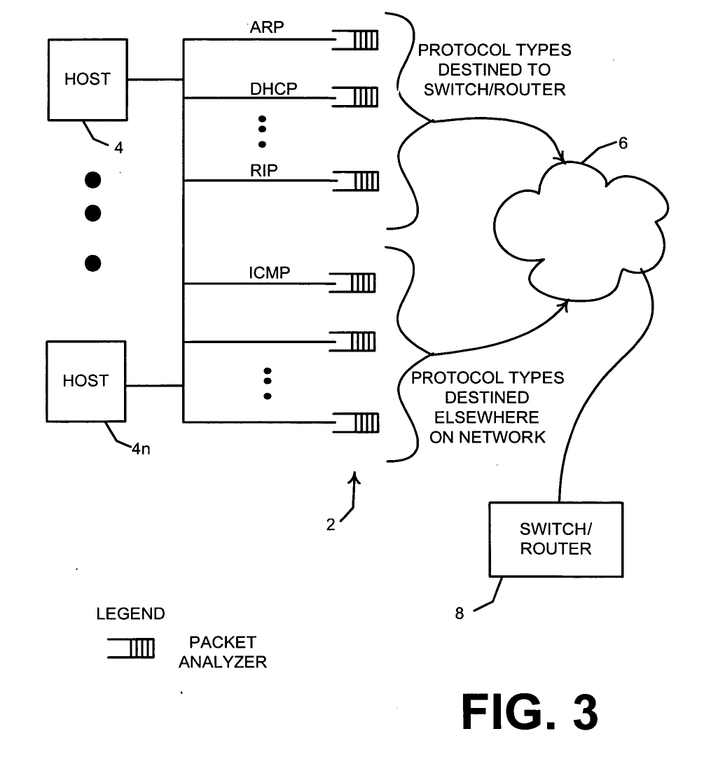

Turning to the figures, FIG. 3 illustrates a configuration of packet analyzers 2 corresponding to a single host 4, or a defined group of hosts 4. It will be appreciated that reference numeral 4 may refer to either a single host, or a group of hosts, where the group may comprise multiple devices that access a network through, for example, a gateway, a cable modem, a DSL modem, or other similar device. Preferably, each packet analyzer is a leaky bucket state machine known in the art. A given host 4 may transmit multiple types of packet traffic to a communication network 6, such as, for example, the Internet. Packet traffic is received by a central device 8, such as a switch or router, which evaluates the content of the traffic packets to determine what to do with them.

In general, switch 8, which, as described above may be a Layer 2 switch or Layer 3 router, inspects traffic stream packets sent by each host, or group of hosts, connected to the switch to determine if the pattern of traffic sent by the host(s) is similar to conventional traffic pattern norms for the network. Traffic whose patterns are deemed to be outside of a range that is predetermined to be ‘normal’ may be dropped, discarded, or throttled. Traffic whose patterns are deemed to be “normal” will be passed.

Traffic that is passed may include packets that contain instructions for the central device's 8 central processor unit (“CPU”) to execute. Other traffic packets may be associated with traffic that is passive, or that is destined for other parts of the network 6, and thus pass through the central device 8 on to their final destination with minimal processing by the central device's processor, or CPU.

Because packets that are generated by network hackers and attackers are generally the same types of packets that would be sent by a well-behaved, legitimate host in the course of normal network operation, simply dropping packet type(s) that are used in a particular attack may also interfere with normal network operation. In addition, inspecting traffic from all hosts connected to a switch can cause the CPU to exhaust its resources at the switch, thus leading to the DoS problem that the attacker is trying to create. Furthermore, it is difficult to give preferential treatment to the traffic from one host over another, because it is not known which host(s) will be acting as an attacker at any point in time.

To accomplish this task, traffic arriving at the switch 8 is first classified into categories of characteristics, or types, known in the art. For example, the classified categories of traffic might include ARP traffic, DHCP traffic, routing protocol traffic (such as RIP, OSPF, BGP, IS-IS, etc.), HTTP-based web surfing traffic, traffic that must be processed by the switch (such as ICMPs), and traffic that the switch must forward. In addition to protocols, other categories of common characteristics may include range of layer 4 ports, range of layer 2 MAC addresses, range of IP addresses, layer 5 identifiers and service identifiers, all of which are known in the art. Other characteristics for relating packets and streams of traffic may be included, or added as DoS attacks evolve. Thus, traffic types are not limited to the categories listed above. However, a common thread among the types of traffic packets that typically cause central device's 8 processor to become overloaded include those that contain instruction for the CPU to execute one or more operations, thus consuming processor resources that could otherwise be used for responding to other requested traffic operations.

For each type of traffic characteristic being analyzed, (i.e., where a packet analyzer 2 is assigned to a particular packet characteristic type), the normal traffic pattern for the particular characteristic or type is assumed to be known, either from empirical measurements or through traffic engineering estimates. The known traffic pattern is then used in determining a threshold to compare actual traffic to.

For example, a host may be permitted to send ARPs into the network, but it might be assumed that under normal operation conditions, a single host should never need to send ARP packets at a rate exceeding one ARP packet per second. Thus, a host that injects ARP packets into the network at a rate exceeding one ARP packet per second may be considered to be outside the ‘normal’ range of ARP operation. Accordingly, a second and subsequent ARP during a given sample period of one second would exceed the 1 ARP per second threshold, and would be discarded.

To determine whether a threshold rate for a particular type of packet is being exceeded during a period, packet analyzers 2 may include a leaky bucket counter state machine. Leaky bucket algorithms are known in the art for measuring whether traffic characteristics (e.g. flow rate for a given packet type/characteristic) of a packet stream are exceeding corresponding thresholds. As further known in the art, a leaky bucket can be implemented in hardware (if high-speed operation is desired) or can be implemented in software (if lower-speed operation is permissible). A hardware aspect is preferably implemented with a field programmable gate array, and a software implementation may be implemented as software code on a compact disc, or similar media. The software code can then be loaded into a computer memory connected to a central device or CMTS at a head end of a cable network operator, or a central office of a DSL operator, for examples.

Regardless of how it is implemented, each leaky bucket 2 instantiation typically has associated with it three variables. These variables include the current depth of the bucket (D) (i.e. the number of packets currently buffered), the high water mark of the bucket (W) (i.e. the threshold), and the period at which the bucket is drained (P).

When a packet is received the bucket depth D is ‘filled’, and thus incremented by one (D=D+1). As each successive sample period P elapses, the bucket depth D is “drained” by one (D=D−1). Therefore, D is derived from the flow rate of packets during P, and the high water mark W corresponds to the threshold that should not be exceeded. Accordingly, the following pseudo code may be used to determine if a packet of a given type should be allowed to pass.

```
If (D < W)
    Increment D;
    Allow packet to pass;
Else
    Drop packet. Algorithm 1
```

As each sample period P elapses the following pseudo code is executed:

If (D > 0)
Decrement D. Algorithm 2

Therefore, a burst of up to W packets may be passed if D=0 when the first packet of the burst arrives, but on average only one packet every P seconds will be allowed to pass. Bursts of greater than W packets within a short period of time will typically result in some packets being dropped.

In an aspect, for each traffic type, or characteristic, a separate leaky bucket state machine is implemented for each host or group of hosts that are known to the switch 8. Thus, if two traffic categories (e.g. ARP and DHCP) are to be monitored for 100 hosts, then 200 unique leaky bucket state machines 2 would be maintained. Each leaky bucket state machine 2 permits packets determined to compose ‘normal’ traffic patterns to pass to the switch for the corresponding traffic type and host corresponding to the state machine.

It will be appreciated that a leaky bucket state machine 2 can be designed to operate on a single host 4 from among a plurality of host, or on a group of hosts within the plurality of hosts. Operating on a single host 4 provides more granularity, or resolution, for the throttling mechanism, with the price being that a larger number of leaky bucket state machines that must be maintained. Operating on a group of hosts offers simplicity because there are fewer leaky bucket state machines 2, with the tradeoff being a lower level of granularity for the throttling mechanism.

If the defined traffic types that are being analyzed are normally routed to the CPU of switch/router 8, then leaky bucket state machines 2 provide protection against localized router/switch attacks. This limits the rate at which packets of a particular type, or characteristic, are delivered to the CPU of the switch 8 from an attacking host 4. However, a benefit is that the protection does not preclude packets of other types from being delivered as desired and the protection does not preclude packets of other hosts 4 from being delivered as desired. Thus, adverse impacts on well-behaved hosts and well-behaved packet flows are minimized, while protection against overloading the CPU of switch 8 with an unusually large amount of operation execution requests from a host, or group of hosts, is minimized.

If the defined traffic types that are being analyzed are normally routed through the switch, then leaky bucket state machines 2 may provide protection against attacks on network devices other than local switch/router 8. These attacks on other devices may include router/switch attacks on remote routers or switches, direct host attacks on remote users, and indirect host attacks that are destined for remote routers in the network, which generate the ICMP unreachable messages.

The protection facilitated by using state machines 2 in this manner limits the rate at which packets of a particular type are delivered to each of those remote end-points. However, a benefit of this approach is that the protection does not preclude packets of other types from being delivered as desired and the protection does not preclude packets of other hosts from being delivered as desired. Thus, the central device CPU protection minimizes negative impacts on well-behaved hosts and well-behaved packet flows while maximizes protection.

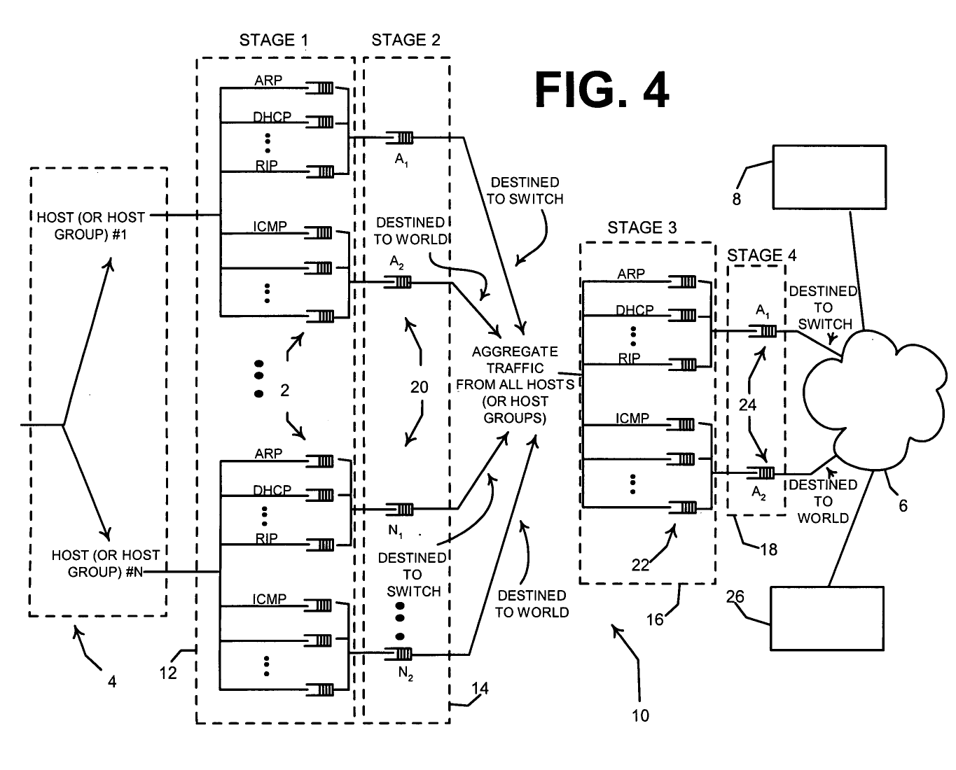

Turning now to FIG. 4, a system 10 incorporates a first stage 12 of packet analyzers as described in reference to FIG. 3 for determining for each of a plurality of characteristic types whether a traffic stream for each of a plurality of hosts 4, or group of hosts 4, connected to a network 6 exceeds a predetermined threshold. In addition, a second stage 14, a third stage 16 and a fourth stage 18 are shown for providing refinement of the protection facilitated by the first stage.

As described above in reference to FIG. 3, the first stage 12 of leaky bucket state machines 2 detects traffic corresponding to individual characteristics for each host 4, or group of hosts, and throttles packets corresponding to particular characteristics according to predetermined criteria, or threshold rates, associated with the particular packet characteristics. In this aspect, a single state machine may throttle streams having packets corresponding to particular characteristic, such that each stream within the plurality of streams is similarly related by common characteristics. For example, packets of multiple TCP streams from a given host, or group of hosts 4, may be throttled by a single state machine 2. However, if resources (hardware silicon or memory for software) are plentiful, a separate state machine 2 may be assigned to each of multiple streams having unique characteristics. Thus, each of multiple TCP streams from the same host could have a dedicated state machine 2 assigned to it. Accordingly, while packets of each of the multiple TCP streams would be similarly related to packets of the other streams, inasmuch as all packets are TCP streams, they are uniquely related to other packets of the stream because they collectively compose a separate stream. Therefore, a separate state machine 2 assigned to a particular stream can identify only packets that are uniquely related to that stream, and only cause dropping of packets of the stream to which it is assigned.

In addition to first stage 12, second stage 14 of leaky bucket state machines 20 analyzes aggregate traffic for each host, or group of hosts 4, with respect to groupings of packets having similarly related characteristics. The traffic packets may be similarly related and grouped according to whether traffic is intended to cause switch 8 to execute instructions, or whether the switch is to merely pass packets on to some other network component. If a user, or host 4, is determined to be sending too much aggregate traffic to either the CPU in the switch—a first similarly related characteristic group, or to the world (i.e., traffic passing through the switch to other destinations of the network)—a second similarly related characteristic group, the appropriate state machine causes extra packets to be discarded, or dropped.

For example, if each individual host 4 is in compliance with host-specific threshold limits for ARP packet traffic, packets are not discarded at first stage 12. However, if each host 4 in host group #1 is sending just barely below the maximum threshold rate as determined in its associated first stage 12 ARP state machine 2, state machine 20A, may determine that in aggregate, all the hosts in host group #1 are sending too many ARP packets according to historical, or estimated, ARP packet maximums. Thus, state machine 20A, may discard ARP packets according to algorithm 1 above.

Thus, first stage 12 of leaky bucket state machines 2 combined with the leaky bucket state machine 20A, of second stage 14 protects against router/switch attacks against the CPU within the router/switch 8. Likewise, first stage 12 in combination with leaky bucket state machine 20A₂ illustrates a throttle that restricts traffic that is destined to hosts other than the CPU of switch 8.

In addition to first stage 12 and second stage 14, third stage 16 is similar to first stage 12 in that it comprises separate state machines 22, one for each type of packet characteristic anticipated that may be susceptible to being hijacked for use in a network attack. However, third stage 16 analyzes aggregate packets from all of hosts 4 rather than a specific host or group of hosts. Third stage 16 of leaky bucket state machines 22 can be implemented so that they do not limit their scope to a particular user or group of users. Even though packets have survived the first and second stages, state machines 22 in third stage 16 analyze different packet types and determine if the aggregate rate combined from all hosts for a particular packet type is exceeding a threshold, and if so, performs the throttling function by causing packets to be dropped.

As with third stage 14 comprising state machines 22, state machines 24 of fourth stage 18 are implemented so as not to limit their scope to a particular user 4, or group of users. Leaky bucket state machine 24A, analyze the aggregate rate combined from all hosts 4 for all packet types combined that are directed at the CPU of switch 8. If this aggregate rate exceeds a predetermined aggregate threshold associated with a characteristic, or type, of packets destined for switch 8, state machine 24A, perform the throttling function according to algorithm 1. This provides even more protection for the CPU of switch 8, because the aggregate total of all hosts 4 will be limited so that the switch processor is not overloaded, thus providing protection against distributed DoS attacks from a large number of coordinated users. Similarly, state machine 24A₂ prevents attacks against other components and devices 26 of network 6 from a large number of coordinated users 4.

The aspects described above are useful when implemented in many different types of network elements. As discussed above, the aspects are useful with respect to switches and routers. Another useful deployment of this invention is within a Cable Modem Termination System (“CMTS”), which serves as the central aggregation point for a Cable Data Network managed by a Cable TV Operator. In a Cable Data Network, the CMTS may include a switch/router at the head-end operated by a Cable TV service provider. It connects to the Internet and connects to a network, typically a coaxial cable, or Hybrid-Fiber Coax plant that runs to subscriber's homes. The hosts within the Cable Data Network are connected to the CMTS via a cable modem, which is a device that resides in a subscriber's home. It is noted that the cable modem itself is also a host. It may be desirable to group the cable modem and the hosts which lie behind it (other devices in the subscriber's home) as a single entity, thus creating a “host group” or “group of hosts” as described above. The CMTS may wish to treat the group of hosts as a whole instead of treating each of these hosts separately. It will be appreciated that this can result in simplification at the CMTS because less state machines will need to be instantiated.

In a Cable Data Network system, it is also possible to deploy the aspects within a cable modem as opposed to deploying it in the CMTS, or in a switch connected to the CMTS, or elsewhere at the head end location. This distributed approach places the leaky bucket state machines for a particular host within the cable modem that is used by that host. As discussed above, the state machines may be implemented as software or as hardware circuits, with speed traded off in favor of lower cost in the former, and lower cost traded off in favor of faster execution in the latter.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents. In addition, although leaky bucket algorithms 1 and 2 described above are preferably used in state machines, other packet control, or policing, algorithms known in the art may be used as deemed appropriate or desirable by traffic engineering personnel.

Furthermore, while the preferred embodiments are described as being preferably directed toward use in DOCSIS networks where a plurality of cable modems are connected over a network via a cable modem termination system, the aspects described herein are equally applicable for other type of networks.

1. A method, comprising:
step for measuring a flow rate of packets corresponding to one or more of a plurality of monitored streams of a group of hosts of a network, said packets having common characteristics relating their corresponding streams to one another;
step for comparing the measured flow rate to a predetermined threshold associated with the common characteristics; and
step for discarding packets from streams for which the packet flow rate exceeds the corresponding predetermined threshold.

2. The method of claim 1 wherein the group of hosts comprises a single host.

3. The method of claim 1 applied at a first stage wherein the common characteristics uniquely relate packets composing a stream such that each stream is distinguished from every other stream.

4. The method of claim 1 applied at a second stage wherein the common characteristics similarly relate packets composing multiple streams such that:
the step for measuring includes measuring an aggregate flow rate for the similarly related streams;
the step for comparing includes comparing the measured aggregate flow rate to an predetermined aggregate threshold; and
the step for discarding includes discarding packets from streams for which the aggregate packet flow rate exceeds the corresponding predetermined aggregate threshold.

5. The method of claim 4 wherein streams are similarly related based on whether the packets of a stream are destined to a central device or to a network device other than a central device.

6. The method of claim 1 wherein the common characteristics may include characteristics selected from the group consisting of protocol types, range of layer 4 ports, range of layer 2 MAC addresses, range of IP addresses, layer 5 identifiers and service identifiers.

7. A method, comprising:
step for measuring an aggregate flow rate of packets corresponding to one or more of a plurality of monitored streams of a plurality of groups of hosts of a network, said packets having common characteristics similarly relating their corresponding streams to one another;
step for comparing the measured aggregate flow rate to a predetermined aggregate threshold associated with the common characteristics; and
step for discarding packets from similarly related streams for which the aggregate flow rate exceeds the corresponding aggregate predetermined threshold.

8. The method of claim 7 wherein one or more of the groups of hosts comprises a single host.

9. The method of claim 7 applied at a third stage wherein the common characteristics may include characteristics selected from the group consisting of protocol types, range of layer 4 ports, range of layer 2 MAC addresses, range of IP addresses, layer 5 identifiers and service identifiers.

10. The method of claim 7 applied at a fourth stage wherein the common characteristics relate streams based on whether the packets of a stream are destined to a central device or to a network device other than a central device.

11. A system, comprising:
means for measuring a flow rate of packets corresponding to one or more of a plurality of monitored streams of a group of hosts of a network, said packets having common characteristics relating their corresponding streams to one another;
means for comparing the measured flow rate to a predetermined threshold associated with the common characteristics; and
means for discarding packets from streams for which the packet flow rate exceeds the corresponding predetermined threshold.

12. The system of claim 11 wherein the group of hosts comprises a single host.

13. The system of claim 11 applied at a first stage wherein the common characteristics uniquely relate packets composing a stream such that each stream is distinguished from every other stream.

14. The system of claim 11 applied at a second stage wherein the common characteristics similarly relate packets composing multiple streams such that:
the step for measuring includes measuring an aggregate flow rate for the similarly related streams;
the step for comparing includes comparing the measured aggregate flow rate to an predetermined aggregate threshold; and
the step for discarding includes discarding packets from streams for which the aggregate packet flow rate exceeds the corresponding predetermined aggregate threshold.

15. The system of claim 14 wherein streams are similarly related based on whether the packets of a stream are destined to a central device or to a network device other than a central device.

16. The system of claim 11 wherein the common characteristics may include characteristics selected from the group consisting of protocol types, range of layer 4 ports, range of layer 2 MAC addresses, range of IP addresses, layer 5 identifiers and service identifiers.

17. The system of claim 11 wherein a leaky bucket state machine comprises the means for measuring, comparing and discarding.

18. The system of claim 17 wherein the leaky bucket state machine is implemented in a CMTS blade, wherein said CMTS blade includes a circuit board and field programmable gate array circuitry.

19. The system of claim 17 wherein the leaky bucket state machine is implemented as computer software code stored on a computer-readable medium.

20. The system of claim 19 wherein the computer readable-medium is a compact disc.

21. The system of claim 17 wherein the leaky bucket state machine is implemented as executable computer software code loaded into a computer memory of a CMTS computer system.
